(19) United States
(12) Patent Application Publication
(10) Pub. No.: US 2012/0311905 A1
(43) Pub. Date: Dec. 13, 2012

(54) DOUBLE-SIDED PRINTED PICTURE AND FRAME UTILIZING EDGE FOLDING

(75) Inventors: Timothy James Dodd, Fairport, NY (US); Brent Rodney Jones, Sherwood, OR (US)

(73) Assignee: XEROX CORPORATION, NORWALK, CT (US)

(21) Appl. No.: 13/156,596

(22) Filed: Jun. 9, 2011

(51) Int. Cl. A47G 1/06; B41F 33/00

(52) U.S. Cl. 40/798; 40/700; 101/483

(57) ABSTRACT

A creased and perforated printable sheet is used with methods to produce framed printed pictures. The sheet comprises a flat sheet of media having a first side, a second side opposite the first side, and sheet edges between the first side and the second side. Perforations and creases are included within the first side and the second side of the sheet of media, and, when folded, produce a three-dimensional effect. The creases and the perforations define a picture region on the first side of the sheet of media and picture frame regions on the second side of the sheet of media. The picture region and the picture frame regions comprise surfaces having a material composition and texture that accepts and maintains marking material applied by printing devices. The perforations also define removable discard regions and tab slots. The removable discard regions are positioned only between the picture frame regions and the sheet edges.

### BACKGROUND

Embodiments herein generally relate to customized media sheets and methods for using such media sheets to print not only a picture or image, but also the frame that will surround the picture or image, where such sheets include perforations, slots, and creases that allow the frame to be folded around the image, thereby creating a three-dimensional picture frame from the printed media sheet.

Businesses or groups who are looking for a new way to distribute event, souvenir or celebrity photos, or individuals who want to print their own photos inside simple, but attractive and customizable frames generally seek improved methods and sheets that present cost-effective, environmentally friendly alternatives to traditional, often expensive photo framing.

### SUMMARY

An exemplary method of printing on a creased and perforated printable sheet herein supplies at least one flat sheet of special media to a printing device. The special media sheet has a first side, a second side opposite the first side, and sheet edges between the first side and the second side of the sheet of media. The sheet of media has perforations and creases within the first side and the second side. The creases and the perforations define a picture region on the first side of the sheet of media and picture frame regions on the second side of the sheet of media. The perforations also define removable discard regions. The largest perforations form tab slots.

One feature of embodiments herein is that the removable discard regions are positioned only between the picture frame regions and the sheet edges, which allows larger pictures to be printed (for a given sheet size), and which reduces the size of the discard regions (thereby reducing waste).

The picture region and the picture frame regions are surfaces having a material composition and texture that is specially designed to readily accept and maintain marking material applied by printing devices. Further, the sheet of media has a material composition, size, and a thickness to allow the sheet of media to be processed through the printing devices and to allow both the first side of the sheet of media and the second side to be printed on by the printing devices. Thus, this exemplary method uses printing devices to print on the picture region and the picture frame regions of the sheet of media. The picture region and the picture frame regions can be both identically blank regions prior to the printing performed by the printing devices.

The method then removes the removable discard regions from the remainder of sheet of media (by tearing along the perforations) to form tabs along exterior edges of the picture frame regions. Next, the method folds the picture frame regions from the second side of the sheet of media to the first side of the sheet of media along the creases producing a three-dimensional picture frame. After this, the method inserts the tabs into the tab slots in a direction from the first side of the sheet of media toward the second side of the sheet of media.

The creases comprise at least two parallel creases within each of the picture frame regions. These parallel creases cause first portions of the picture frame regions to be positioned approximately perpendicular to the first side of the sheet of media after the picture frame regions have been folded from the second side of the sheet of media to the first side of the sheet of media, thereby producing a three-dimensional picture frame from the special sheet of media. The parallel creases further cause second portions of the picture frame regions to form an acute angle with the first side of the sheet of media after the picture frame regions have been folded from the second side of the sheet of media to the first side of the sheet of media, further increasing the three-dimensional effect.

An exemplary creased and perforated printable sheet for use with methods herein comprises a flat sheet of media having a first side, a second side opposite the first side, and sheet edges between the first side and the second side. Perforations and creases are included within the first side and the second side of the sheet of media. The creases and the perforations again define a picture region on the first side of the sheet of media and picture frame regions on the second side of the sheet of media. The perforations also define removable discard regions and the largest perforations form tab slots. The removable discard regions are positioned only between the picture frame regions and the sheet edges.

The first side of the sheet of media has a first-side center point positioned equidistant from opposing ones of the sheet edges. Similarly, the second side of the sheet of media also has a second-side center point positioned equidistant from opposing ones of the sheet edges. The picture region is centered on the first-side center point. Also, pairs of opposing ones of the picture frame regions are positioned equidistant from the second-side center point. The picture region and the picture frame regions comprise surfaces that have a material composition and texture that accepts and maintains marking material applied by printing devices. Therefore, the special sheets of media described herein work well with conventional printing devices.

Once the printing has been completed on the picture region and the picture frame regions, the removable discard regions can be removed from the sheet of media. The perforations are patterned to form tabs at outer edges of the picture frame regions after the discard regions are removed. The creases are patterned to allow the picture frame regions to be folded toward the first side of the sheet of media and to allow the tabs to be inserted into the tab slots in a direction from the first side of the sheet of media to the second side of the sheet of media.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a perspective schematic diagram of a perforated sheet according to embodiments herein;

FIG. 2 is a perspective schematic diagram of a perforated sheet according to embodiments herein;

FIG. 3 is a perspective schematic diagram of a perforated sheet according to embodiments herein;

FIG. 4 is a perspective schematic diagram of a perforated sheet according to embodiments herein;

FIG. 5 is a perspective schematic diagram of a perforated sheet according to embodiments herein;

FIG. 6 is a perspective schematic diagram of a perforated sheet according to embodiments herein;

FIG. 7 is a perspective schematic diagram of a perforated sheet according to embodiments herein;

FIG. 8 is a perspective schematic diagram of a perforated sheet according to embodiments herein;

FIG. 9 is a perspective schematic diagram of a perforated sheet according to embodiments herein;

FIG. 10 is a flow diagram illustrating various method embodiments herein;

FIG. 11 is a perspective schematic diagram of a perforated sheet according to embodiments herein;

FIG. 12 is a perspective schematic diagram of a perforated sheet according to embodiments herein;

FIG. 13 is a schematic diagram of a perforated sheet according to embodiments herein;

FIG. 14 is a perspective diagram of a perforated sheet according to embodiments herein; and

FIG. 15 is a side-view diagram of a printing machine according to embodiments herein.

### DETAILED DESCRIPTION

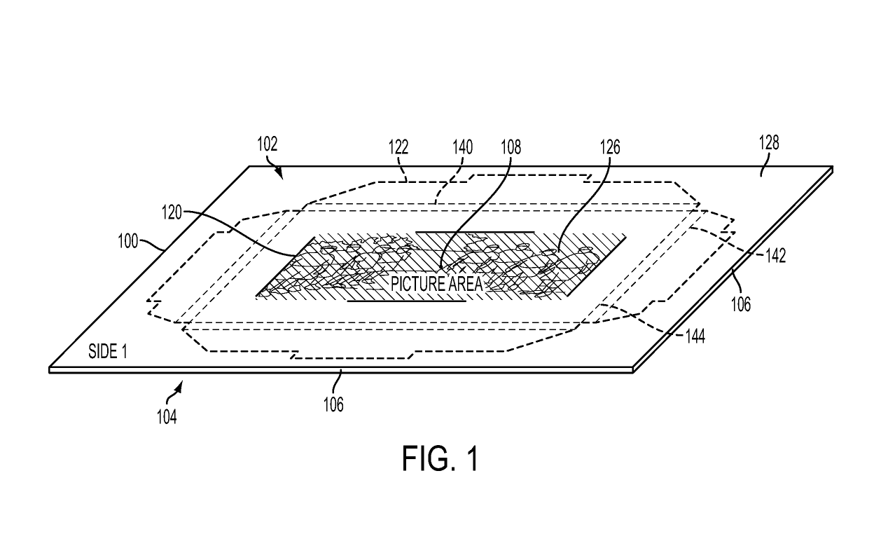

As mentioned above, individuals who want to print their own photos inside simple, but attractive and customizable frames generally seek improved methods and sheets that present cost-effective, environmentally friendly alternatives to traditional, often expensive photo framing. In view of this, the embodiments herein provide creased and perforated printable sheets 100, as shown in FIG. 1.

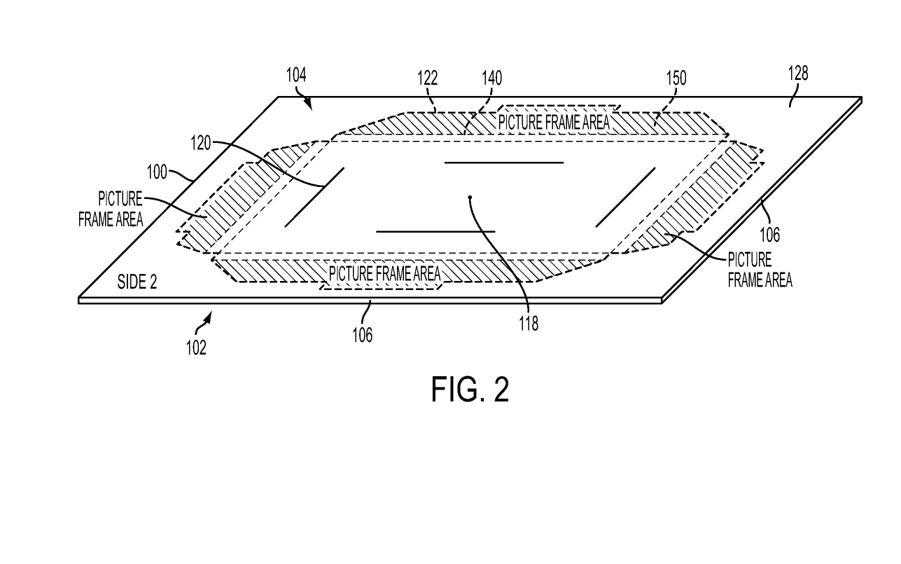

More specifically, FIGS. 1 and 2 illustrate a flat sheet of media 100 having a first side 102, a second side 104 opposite the first side 102, and sheet edges 106 between the first side 102 and the second side 104. Perforations 122 and creases 140 are included within the first side 102 and the second side 104 of the sheet of media 100. The creases 140 and the perforations 122 define a picture region 126 on the first side 102 of the sheet of media 100 and picture frame regions 150 on the second side 104 of the sheet of media 100. The perforations 122 also define removable discard regions 128 and the largest perforations 122 form tab slots 120. The removable discard regions 128 are positioned only between the picture frame regions 150 and the sheet edges 106.

The first side 102 of the sheet of media 100 has a first-side center point 108 positioned equidistant from opposing ones of the sheet edges 106. Similarly, the second side 104 of the sheet of media 100 also has a second-side center point 118 positioned equidistant from opposing ones of the sheet edges 106. The picture region 126 is approximately centered on the first-side center point 108. Also, pairs of opposing ones of the picture frame regions 150 are positioned approximately equidistant from the second-side center point 118.

The picture region 126 and the picture frame regions 150 comprise surfaces that have a material composition and texture that accepts and maintains marking material applied by printing devices. For example, the sheet of media 100 can be formed of standard copy paper, transparencies, card stock, as well as any other material that is commonly used for printing (whether currently known or developed in the future). Therefore, the special sheets of media described herein work well with conventional duplex printing devices.

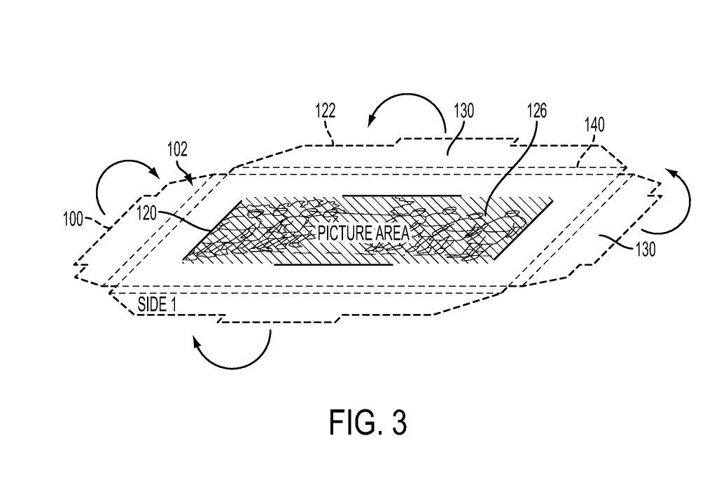

Once the printing has been completed on the picture region 126 and the picture frame regions 150, the removable discard regions 128 can be removed from the sheet of media 100 as shown in FIG. 3. The perforations 122 can have any appropriate size and spacing for a given media sheet type and are patterned to form tabs 130 at outer edges of the picture frame regions 150 after the discard regions 128 are removed.

As shown by the arrows in FIG. 3, the creases 140 are patterned to allow the picture frame regions 150 printed on the second side 104 to be folded toward the first side 102 of the sheet of media 100 and to allow the tabs 130 to be inserted into the tab slots 120 in a direction from the first side 102 of the sheet of media 100 to the second side 104 of the sheet of media 100. Therefore, with embodiments herein, the picture frame portions 150 border the edges of 106 of the sheet of media 100 and each picture frame portion 150 is individually folded toward side 1 (102) in an edge folding process. In doing so, each of the picture frame portions 150 is folded in a different direction (e.g., to the left, to the right, from the top, from the bottom) and toward an opposing picture frame portion as each is folded from side 2 to side 1, which produces a three-dimensional picture frame around the picture.

One feature of embodiments herein is that the removable discard regions 128 are positioned only between the picture frame regions 150 and the sheet edges 106, which allows larger pictures to be printed (for a given sheet size) and which reduces the size of the discard regions 128 (thereby reducing waste). To the contrary, conventional sheets that are folded into picture frames receive a picture in (or print a picture on) one half of the sheet and then fold the sheet in half to create the picture frame. Such conventional structures and processes produce larger amounts of waste and provide smaller areas for the picture when compared to the embodiments herein that do not fold the sheet in half. To the contrary, the embodiments herein can print the picture frame regions 150 very close to the edges 106 of the sheet of media 100, thereby allowing a larger picture region 126.

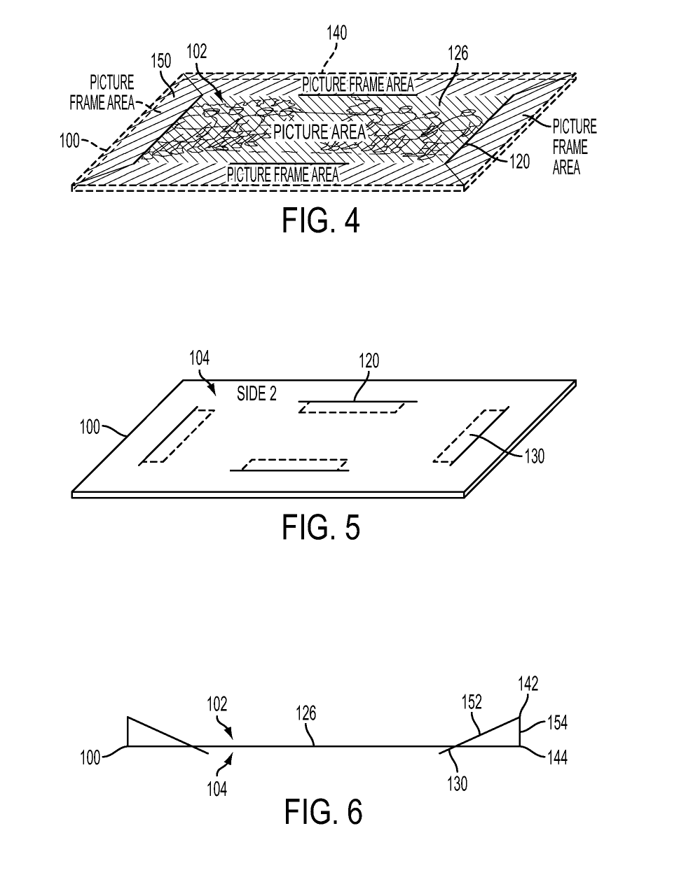

FIG. 4 illustrates the sheet of media 100 viewed from side 1 after the picture frame regions 150 have been folded towards side 1 (102) and the tabs 130 have been inserted into the tab slots 120. FIG. 5 illustrates the same viewed from side 2 (104) where the tabs 130 can be seen protruding through the tab slots 120. FIG. 6 illustrates the same viewed from the side of the sheet of media 100.

As shown in FIG. 1, the creases 140 comprise at least two parallel creases 142, 144 bordering each of the picture frame regions 150. As shown in FIG. 6, these parallel creases 142, 144 cause first portions 154 of the picture frame regions 150 to be positioned approximately perpendicular to the first side 102 of the sheet of media 100 after the picture frame regions 150 have been folded from the second side 104 of the sheet of media 100 to the first side 102 of the sheet of media 100, thereby producing a three-dimensional picture frame from the special sheet of media 100. As also shown in FIG. 6, the parallel creases 142, 144 further cause second portions 152 of the picture frame regions 150 to form an acute angle with the first side 102 of the sheet of media 100 when the picture frame regions 150 are folded from the second side 104 of the sheet of media 100 to the first side 102 of the sheet of media 100, further increasing the three-dimensional effect.

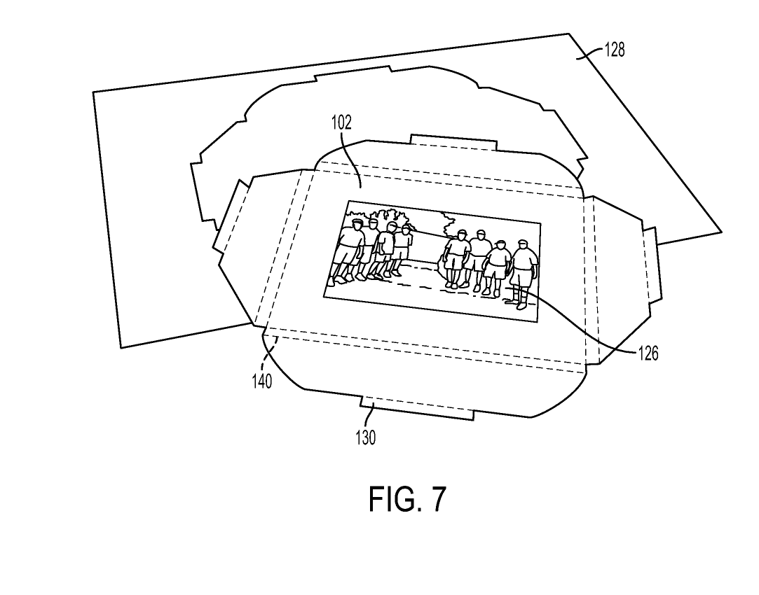

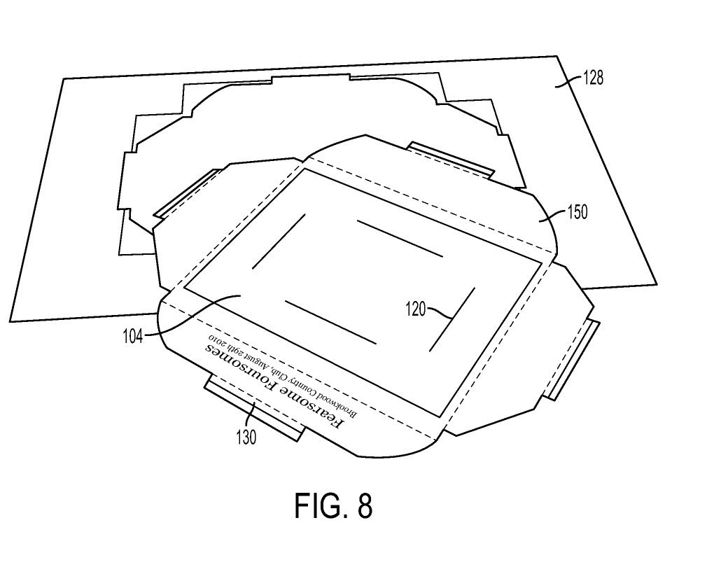

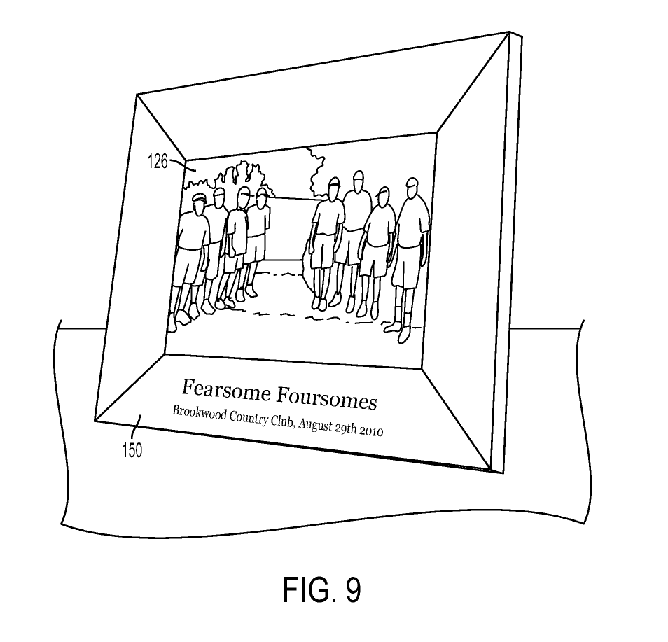

FIGS. 7-9 are perspective schematic diagrams illustrating one example of the sheet of media 100 having a photograph printed in the picture region 126 and a wood grain border printed in the picture frame region 150. Note that in FIGS. 7-9, the picture frame region 150 includes text printed along with the wood grain. In addition to text, with embodiments herein, the picture frame region 150 can include any other printed item including graphics, patterns, colors, etc.

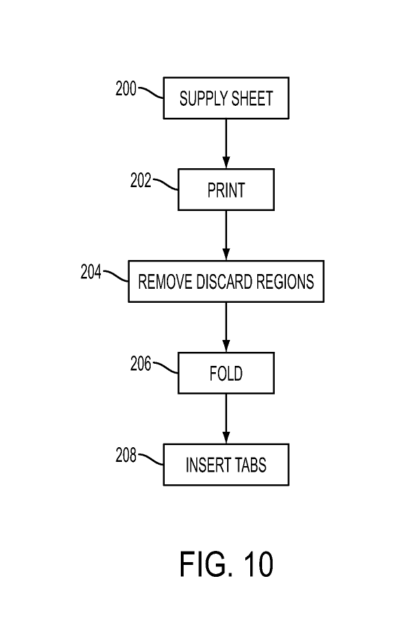

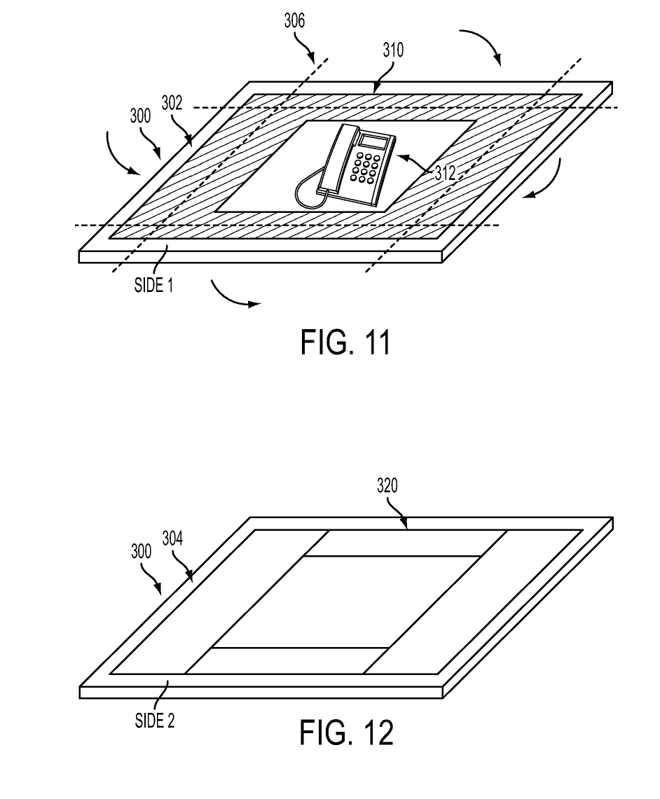

FIG. 10 illustrates an exemplary method of printing on a creased and perforated printable sheet in flowchart form. In item 200, this exemplary method supplies at least one flat sheet of special media to a printing device (illustrated in FIG. 11, discussed below).

As discussed above, the picture region 126 and the picture frame regions 150 are surfaces having a material composition and texture that is specially designed to readily accept and maintain marking material applied by printing devices. Further, the sheet of media 100 has a material composition, size, and a thickness to allow the sheet of media 100 to be processed through a printing device and to allow both the first side 102 of the sheet of media 100 and the second side 104 to be printed on by the printing device. Thus, in item 202 this exemplary method uses the printing device to print on the picture region 126 and the picture frame regions 150 of the sheet of media 100. The picture region 126 and the picture frame regions 150 can be both identically blank regions prior to the printing performed by the printing device.

The method then removes the removable discard regions 128 from the remainder of sheet of media 100 (by tearing along the perforations 122) to form tabs 130 along exterior edges of the picture frame regions 150 in item 204. Next, the method folds the picture frame regions 150 from the second side 104 of the sheet of media 100 to the first side 102 of the sheet of media 100 along the creases 140 in item 206. After this, the method inserts the tabs 130 into the tab slots 120 in a direction from the first side 102 of the sheet of media 100 toward the second side 104 of the sheet of media 100 in item 208.

Therefore, the embodiments herein provide the look of real three-dimensional framed photos without the expense of conventional plastic, metal, or glass frames. Further, the embodiments herein provide the ability to personalize such frames as they are printed. With the embodiments herein, the user simply inserts the special perforated and creased media sheets into a printing device. Then, using any conventional software programs, one or more photographs or images can be selected for printing. In addition, the appearance of the frame (and any custom message or lettering) can also be selected. These items can, for example, be selected and positioned within a prepared template on graphic user interface to provide the user a graphical indication of how the completed print job will appear. Then, using duplex printing, both sides of the special media sheets can be printed to create the picture and frame, as illustrated above.

Alternatively, a two-sided physical template can be positioned on the platen of the multi-function printing device. One side of the physical template can be used to properly position the item that is to be copied onto the first side of the special media sheets. The reverse side of the template can contain an image of the frame which can be copied on to the second side of the special media sheets to produce the picture and frame, as illustrated above.

This application gives users many options to personalize their photos and frames. For example, the picture and frame media sheets described above can be utilized to produce themed frames can be used for Holiday, Birthday or Birth Announcements. Alternatively, school teachers can take digital photos of their class and then provide their students with framed photographs using the special media sheets and methods described above.

For purposes herein, perforations comprise a series of openings within the sheet of media that are aligned, sized, and spaced to cause of the sheet of media to tear cleanly along the perforation line when the media is pulled apart by a user. Additionally, for purposes herein, creases are areas of the sheet of media that have been compressed (relative to the non-creased areas of the sheet of media) in a manner that causes the sheet of media to fold cleanly along the creases when folded by the user.

While the above-described embodiments utilize a sheet of media that is specifically manufactured to include perforations and creases, in other embodiments the sheet that is utilized can comprise a flat unaltered blank sheet. In these embodiments, the same processes described above are utilized; however, rather than using a sheet that is manufactured to include perforations increases, these embodiments print separation (cut) lines and fold lines in the locations where the perforations and creases are located in the other embodiments. In such embodiments, the separation lines and fold lines can be printed in advance when the sheets of media are manufactured; alternatively, the separation lines and fold lines can be printed simultaneously while printing the picture region and picture frame regions. Therefore, in the drawings, items 122 also represent printed separation lines (cut lines) that will be cut by a user (using scissors or other cutting implements). Similarly, in the drawings, items 140 also represent printed fold lines that guide the user when making the folds that are described above. With such embodiments, the cost is reduced because the sheets of media can comprise any available media stock and do not need to be specifically manufactured with perforations and creases.

Additional embodiments are illustrated in FIGS. 11-14. In these embodiments, a picture frame image 310 and a picture image 312 are simultaneously printed on a first side 302 of a sheet of media 300. As shown, the picture frame image 310 surrounds the picture image 312. In addition, separation lines and fold lines 320 are printed on the opposite side (side 2) 304 of the sheet of media 300, as shown in FIG. 12. The printing that occurs on the first side 302 and the second side 304 of the sheet of media 300 can be performed by different printers or can be performed by the same printer in, for example, a duplex printing operation.

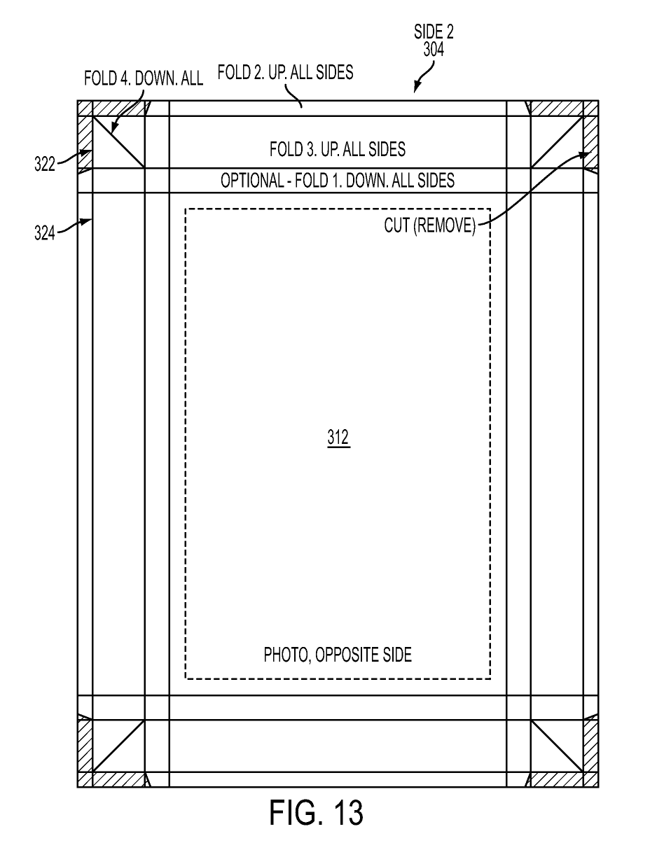

FIG. 13 illustrates separation lines and fold lines 320 that can be printed on the second side 304 of the sheet of media 300. FIG. 13 illustrates more specific separation lines 322 and fold lines 324. As illustrated in FIG. 13, after the separation lines 322 are cut by the user (using any common cutting device, such as scissors, a knife, etc.) the folds can be performed in a specific order (e.g., Fold 1, Fold 2, Fold 3, etc.).

Further, for reference, the location of the picture or photograph 312 that is located on side one 302 is also shown in FIG. 13 (using dashed lines). As mentioned above, the picture or photograph 312 is only printed on the first side 302 and is not printed on the second side 304 of this sheet of media (and is only illustrated in FIG. 13 as a locational reference). As shown in FIG. 13, all fold lines that are printed on the second side 304 are outside the corresponding location of the picture or photograph 312 that is printed on the first side 302.

The folding process itself is illustrated by the curved arrows in FIG. 11. FIG. 11 also illustrates various dashed lines 306 which identify locations where the folds will be made. Note that dashed lines 306 may not be printed, but are included in FIG. 11 to illustrate where the user will fold the sheet of media 300 when they follow the fold lines 320 that are printed on the second side 304 of the sheet of media 300. As shown by the curved arrows in FIG. 11, the edges of the sheet of media are folded from the first side 302 back around toward the second side 304 and the folded portions of the sheet of media 300 may be attached to each other using, for example, tape, glue, staples, etc. (as necessary).

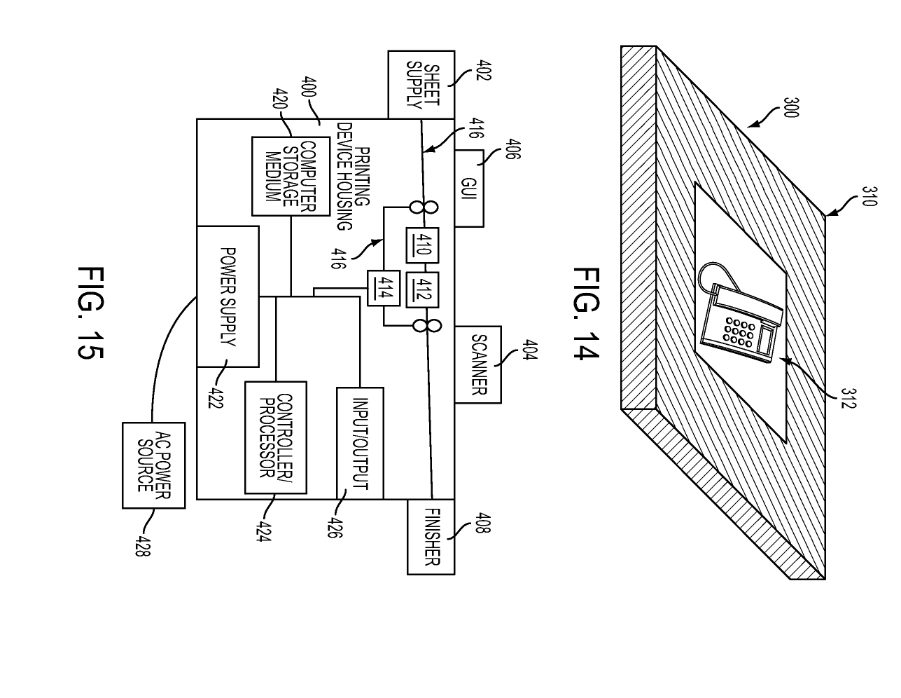

FIG. 14 illustrates the sheet of media 300 after it is folded along the fold lines 320 and taped. In this embodiment, the folds 306 are located in the middle of the printed area of the frame 310 to give the frame a three-dimensional effect. More specifically, by locating the folds 306 within the printed area of the frame 310, the front as well as the sides of the frame will receive the printing of the frame image 310, giving the appearance of a three dimensional piece of material. In addition, as illustrated in FIG. 13, the fold lines 324 include multiple parallel folds that are outside the printed image region 312 and are made in the same direction, causing and sections of the folded frame area 310 to be positioned at right angles with respect to each other, giving the folded sheet of media 300 a three dimensional structure. The second side border fold region may include a suggested hole punch or cut region for a centering notch or “V” (not illustrated) to facilitate hanging the finalized framed picture.

The embodiments herein are advantageous because they can create three-dimensional framed picture or photograph from an otherwise plain sheet of media. This substantially reduces the cost of such a product and does not require specialized media or any modifications to existing printing devices. This allows three-dimensional framed pictures to be easily produced by anyone having access to a standard printing device.

FIG. 15 illustrates a computerized printing device 400, which can be used with embodiments herein and can comprise, for example, a printer, copier, multi-function machine, etc. The printing device 400 includes a controller/processor 424, at least one marking device (printing engines) 410, 412, 414 operatively connected to the processor 424, a media path 416 positioned to supply sheets of media from a sheet supply 402 to the marking device(s) 410, 412, 414, and a communications port (input/output) 426 operatively connected to the processor 424 and to a computerized network external to the printing device. After receiving various markings from the printing engine(s), the sheets of media can optionally pass to a finisher 408 which can fold, staple, sort, etc., the various printed sheets.

Also, the printing device 400 can include at least one accessory functional component (such as a scanner/document handler 404, sheet supply 402, finisher 408, etc.) and graphic user interface assembly 406 that also operate on the power supplied from the external power source 428 (through the power supply 422).

The input/output device 426 is used for communications to and from the multi-function printing device 400. The processor 424 controls the various actions of the printing device. A non-transitory computer storage medium device 420 (which can be optical, magnetic, capacitor based, etc.) is readable by the processor 424 and stores instructions that the processor 424 executes to allow the multi-function printing device to perform its various functions, such as those described herein.

Thus, a printer body housing 400 has one or more functional components that operate on power supplied from the alternating current (AC) 428 by the power supply 422. The power supply 422 connects to an external alternating current power source 428 and converts the external power into the type of power needed by the various components.

As would be understood by those ordinarily skilled in the art, the printing device 400 shown in FIG. 15 is only one example and the embodiments herein are equally applicable to other types of printing devices that may include fewer components or more components. For example, while a limited number of printing engines and paper paths are illustrated in FIG. 15, those ordinarily skilled in the art would understand that many more paper paths and additional printing engines could be included within any printing device used with embodiments herein.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to most modern printing devices but are most applicable to “plain” media imaging technologies such as electrostatographic, electrophotographic and similar machines and/or processes as well as direct or offset ink jet and solid ink printers.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user. Plain media refers to imaging substrates that need not be coated or is not unique to a specialized imaging technology, for example, dye sublimation requires special media.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

1. A creased and perforated printable sheet comprising:
a flat sheet of media having a first side, a second side opposite said first side, and sheet edges between said first side of said sheet of media and said second side of said sheet of media;
perforations within said first side of said sheet of media and said second side of said sheet of media; and
creases within said first side of said sheet of media and said second side of said sheet of media,
said creases and said perforations defining a picture region and four picture frame regions with tabs,
said picture region being essentially rectangular in shape with four picture edges and being centered on said first side of said sheet of media,
said four picture frame regions being adjacent to said sheet edges on said second side of said sheet of media,
said picture region and said four picture frame regions comprising surfaces having a material composition and texture that accepts and maintains marking material applied by printing devices,
said perforations further defining removable discard regions and four tab slots,
said four tab slots being parallel and immediately adjacent to said four picture edges and further being parallel to and spaced a same distance from said creases so as to receive said tabs on said picture frame regions when said picture frame regions are subsequently folded along said creases, and
said removable discard regions being positioned between and immediately adjacent to each of said four picture frame regions and said sheet edges.

2. The creased and perforated printable sheet according to claim 1, said creases comprising at least two parallel creases within each of said picture frame regions,
said parallel creases causing first portions of said picture frame regions to be positioned approximately perpendicular to said first side of said sheet of media when said picture frame regions are folded from said second side of said sheet of media to said first side of said sheet of media.

3. The creased and perforated printable sheet according to claim 2, said parallel creases further causing second portions of said picture frame regions to form an acute angle with said first side of said sheet of media when said picture frame regions are folded from said second side of said sheet of media to said first side of said sheet of media.

4. The creased and perforated printable sheet according to claim 1, said picture region and said picture frame regions both comprising identically blank regions prior to being printed upon by said printing devices.

5. The creased and perforated printable sheet according to claim 1, said sheet of media comprising a material composition, size, and a thickness to allow said sheet of media to be processed through said printing devices and to allow both said first side of said sheet of media and said second side to be printed on by said printing devices.

6. A creased and perforated printable sheet comprising:
a flat sheet of media having a first side, a second side opposite said first side, and sheet edges between said first side of said sheet of media and said second side of said sheet of media;
perforations within said first side of said sheet of media and said second side of said sheet of media; and
creases within said first side of said sheet of media and said second side of said sheet of media,
said creases and said perforations defining a picture region and four picture frame regions with tabs,
said picture region being essentially rectangular in shape with four picture edges and on said first side of said sheet of media,
said four picture frame regions being adjacent to said sheet edges on said second side of said sheet of media,
said picture region and said four picture frame regions comprising surfaces having a material composition and texture that accepts and maintains marking material applied by printing devices,
said first side of said sheet of media having a first-side center point positioned equidistant from opposing ones of said sheet edges,
said second side of said sheet of media having a second-side center point positioned equidistant from opposing ones of said sheet edges,
said picture region being centered on said first-side center point,
pairs of opposing ones of said four picture frame regions being positioned equidistant from said second-side center point,
said perforations further defining removable discard regions and four tab slots,
said four tab slots being parallel and immediately adjacent to said four picture edges and further being parallel to and spaced a same distance from said creases so as to receive said tabs on said picture frame regions when said picture frame regions are subsequently folded along said creases, and
said removable discard regions being positioned between and immediately adjacent to each of said four picture frame regions and said sheet edges.

7. The creased and perforated printable sheet according to claim 6, said creases comprising at least two parallel creases within each of said picture frame regions,
said parallel creases causing first portions of said picture frame regions to be positioned approximately perpendicular to said first side of said sheet of media when said picture frame regions are folded from said second side of said sheet of media to said first side of said sheet of media.

8. The creased and perforated printable sheet according to claim 7, said parallel creases further causing second portions of said picture frame regions to form an acute angle with said first side of said sheet of media when said picture frame regions are folded from said second side of said sheet of media to said first side of said sheet of media.

9. The creased and perforated printable sheet according to claim 6, said picture region and said picture frame regions both comprising identically blank regions prior to being printed upon by said printing devices.

10. The creased and perforated printable sheet according to claim 6, said sheet of media comprising a material composition, size, and a thickness to allow said sheet of media to be processed through said printing devices and to allow both said first side of said sheet of media and said second side to be printed on by said printing devices.

11. A method of printing on a printable sheet comprising:
supplying, to a printing device, a flat sheet of media having a first side, a second side opposite said first side, and sheet edges between said first side of said sheet of media and said second side of said sheet of media,
said sheet of media comprising separation lines and fold lines within said first side and said second side,
said fold lines and said separation lines defining a picture region and four picture frame regions with tabs,
said picture region being essentially rectangular in shape with four picture edges and being centered on said first side of said sheet of media,
said four picture frame regions being adjacent to said sheet edges on said second side of said sheet of media,
said picture region and said four picture frame regions comprising surfaces having a material composition and texture that accepts and maintains marking material applied by printing devices,
said separation lines further defining removable discard regions and four tab slots,
said four tab slots being parallel and immediately adjacent to said four picture edges and further being parallel to and spaced a same distance from said fold lines, and
said removable discard regions being positioned between each of said four picture frame regions and said sheet edges;
printing, using said printing device, on said picture region on said first side and on said picture frame regions on said second side of said sheet of media;
removing said removable discard regions from said sheet of media to expose said tabs along exterior edges of said four picture frame regions;
folding said picture frame regions from said second side of said sheet of media to said first side of said sheet of media along said fold lines; and
inserting said tabs into said tab slots in a direction from said first side of said sheet of media toward said second side of said sheet of media.

12. The method of printing on a printable sheet according to claim 11, further comprising printing said separation lines and said fold lines on said printable sheet.

13. The method of printing on a printable sheet according to claim 11, said separations lines comprising perforations and said fold lines comprising creases within said printable sheet.

14. The method of printing on a printable sheet according to claim 13, said creases comprising at least two parallel creases within each of said picture frame regions,
said parallel creases causing first portions of said picture frame regions to be positioned approximately perpendicular to said first side of said sheet of media when said picture frame regions are folded from said second side of said sheet of media to said first side of said sheet of media.

15. The method of printing on a printable sheet according to claim 14, said parallel creases further causing second portions of said picture frame regions to form an acute angle with said first side of said sheet of media when said picture frame regions are folded from said second side of said sheet of media to said first side of said sheet of media.

16. A method of printing a framed image on a printable sheet comprising:
supplying, to a printing device, a flat sheet of media having a first side and a second side opposite said first side;
printing, using said printing device, a picture region and a picture frame region on said first side of said sheet of media, said picture frame region surrounding said picture region;
printing, using said printing device, separation lines and fold lines on said second side of said sheet of media;
cutting said separation lines;
folding said fold lines in a process that folds said picture frame regions from said first side of said sheet of media to said second side of said sheet of media along said fold lines; and
attaching folded portions of said sheet of media to create a three dimensional frame surrounding said picture region.

17. The method of according to claim 16, said fold lines being positioned on said second side of sheet of media such that said folding creates folds along said picture frame region.

18. The method of according to claim 16, said picture region and said picture frame region being printed simultaneously.

19. The method of according to claim 16, said fold lines comprising multiple parallel lines that are positioned outside a regions corresponding to said picture region.

20. The method of according to claim 16, said printing of said picture frame regions, said picture regions, said separation lines, and fold lines comprising a duplex printing process.
